(19) United States
(12) Patent Application Publication
(10) Pub. No.: US 2017/0213373 A1
(43) Pub. Date: Jul. 27, 2017

(54) INFORMATION PROCESSING DEVICE, INFORMATION PROCESSING METHOD, AND NON-TRANSITORY COMPUTER-READABLE RECORDING MEDIUM

(71) Applicant: FUJITSU LIMITED, Kawasaki-shi (JP)

(72) Inventor: Sosuke Yamao, Atsugi-shi (JP)

(73) Assignee: FUJITSU LIMITED, Kawasaki-shi (JP)

(21) Appl. No.: 15/373,595

(22) Filed: Dec. 9, 2016

(30) Foreign Application Priority Data
Jan. 25, 2016 (JP) 2016-011668

(51) Int. Cl. G06T 11/60; G06T 3/40; G06T 7/73

(52) U.S. Cl. CPC G06T 11/60; G06T 7/73; G06T 3/40; G06T 2207/20221

(57) ABSTRACT

A worker terminal acquires information on a characteristic point of a subject, which is included in image information captured by a camera, and position/posture information of the camera. A worker terminal computes a distance from the camera to the subject based on the acquired information on the characteristic point and the acquired position/posture information. A remote support device changes a scale of image information that is arranged to generate a panorama image in accordance with the computed distance.

### CROSS-REFERENCE TO RELATED APPLICATION(S)

This application is based upon and claims the benefit of priority of the prior Japanese Patent Application No. 2016-011668, filed on Jan. 25, 2016, the entire contents of which are incorporated herein by reference.

### FIELD

The embodiment discussed herein is related to an information processing device, an information processing method, and a non-transitory computer-readable recording medium.

### BACKGROUND

Currently, a working field is confronted with problems such as labor shortage and fosterage of a practicing engineer, and thus to deploy an expert in every working field is difficult in some cases. There exists a system to solve the problem, by which an expert gives an instruction to a worker that is working in a remote location while grasping remote information to coordinately perform a work. Moreover, the work can be efficiently performed by the combined use of an Augmented Reality technology (AR technology) in which virtual world information is superimposed on an image of an actual environment captured by a camera and information is provided to the worker.

FIG. 19 is a diagram illustrating one example of a conventional system. In the system illustrated in FIG. 19, a case is illustrated as an example, in which a worker 2 in a working field performs a work on the basis of an instruction from an indicator 1. The worker 2 wears a worker terminal 50, a display device 21d, and a camera 21c. The worker terminal 50 is connected to the display device 21d and the camera 21c by wireless communication, etc. An image frame 2c, which includes a two-dimensional image (2D image) captured by the camera 21c of the worker 2, is transmitted to a remote support device 60 of the indicator 1 by a wireless network communication function of the worker terminal 50. For example, a region illustrated by an image of the image frame 2c is expressed by a visual field 7d.

The remote support device 60 is operated by the indicator 1. The remote support device 60 generates a three-dimensional panorama image (3D panorama image) 4 from the image frame 2c transmitted from the worker terminal 50 in the remote location, and displays it. The indicator 1 grasps a situation of the working field in the remote location from the three-dimensional panorama image 4 that is displayed on the remote support device 60. The three-dimensional panorama image 4 is updated every time when the image frame 2c is received.

The indicator 1 clicks, for example, a spot to which an instruction is to be given in the three-dimensional panorama image 4. Position information on a position in the image frame 2c that is clicked by the indicator 1 and instruction information 2f that includes instruction's contents 2g and the like are transmitted from the remote support device 60 to the worker terminal 50. When receiving the instruction information 2f, the worker terminal 50 causes the display device 21d to display the instruction's contents 2g. The worker 2 refers to the instruction's contents 2g displayed on the display device 21d to perform a work.

One example of a conventional process will be explained, by which the three-dimensional panorama image 4 is generated. The conventional technology calculates position/posture information on the camera 21c having captured the image frame 2c on the basis of a Simultaneous Localization And Mapping technology (SLAM technology), etc. The conventional technology generates a frustum-shaped three-dimensional image drawing object by using the position/posture information of the camera and a preliminarily acquired internal parameter of the camera 21c, and performs texture mapping of the image frame 2c on a base of the three-dimensional image drawing object. The conventional technology arranges the texture mapped three-dimensional image drawing object on the three-dimensional space on the basis of the position/posture information on the camera 21c. The conventional technology repeatedly executes the aforementioned process to generate the three-dimensional panorama image 4.

Patent Literature 1: Japanese Laid-open Patent Publication No. 2011-159162

However, with regard to the aforementioned conventional technology, there exists a problem that a panorama image is not appropriately generated.

For example, in the process for generating and arranging a three-dimensional image drawing object with the movement of the camera 21c, because a three-dimensional image drawing object is not appropriately generated in the conventional technology, misalignment occurs in a three-dimensional panorama image.

FIGS. 20 and 21 are diagrams illustrating a problem of a conventional technology. In FIG. 20, an image frame 3a is an image frame that is captured by the camera 21c at a first timing, and an image frame 3b is an image frame that is captured by the camera 21c at a second timing that is different from the first timing. For example, in the conventional technology, a three-dimensional image drawing object is generated from image frames 1 and 2, a three-dimensional panorama image 4a is generated, it becomes the one exemplified in FIG. 21. In this case, misalignment may occur in the three-dimensional panorama image 4a. In the example illustrated in FIG. 21, although two subjects are illustrated, there really exists only one subject.

### SUMMARY

According to an aspect of an embodiment, an information processing device includes a processor that executes a process including: acquiring information on a characteristic point of a subject, which is included in image information captured by a photographing device, and position/posture information of the photographing device; computing a distance from the photographing device to the subject based on the information on the characteristic point and the position/posture information; and changing a scale of image information that is arranged to generate a panorama image in accordance with the distance.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a reference technology;

FIG. 2 is a diagram illustrating a configuration of a system according to an embodiment;

FIG. 3 is a functional block diagram illustrating a configuration of a worker terminal according to the embodiment;

FIGS. 4 to 6 are diagrams illustrating examples of “M_{P}” in a set “P′”;

FIG. 7 is a functional block diagram illustrating a configuration of a remote support device according to the embodiment;

FIG. 8 is a diagram illustrating one example of a data structure of a management table;

FIG. 9 is a diagram illustrating one example of a data structure of a panorama image table;

FIG. 10 is a diagram illustrating one example of a reference object;

FIGS. 11 and 12 are diagrams illustrating examples of a changing process of a scale of the reference object;

FIG. 13 is a diagram illustrating a calculating process of an optimum value of a geometric distance;

FIG. 14 is a flowchart illustrating a processing procedure by the worker terminal according to the embodiment;

FIG. 15 is a flowchart illustrating a processing procedure by the remote support device according to the embodiment;

FIG. 16 is a diagram illustrating a conventional referential three-dimensional panorama image;

FIG. 17 is a diagram illustrating a three-dimensional panorama image that is generated in the embodiment;

FIG. 18 is a diagram illustrating one example of a computer that executes an information processing program;

FIG. 19 is a diagram illustrating one example of a conventional system; and

FIGS. 20 and 21 are diagrams illustrating a problem of a conventional technology.

### DESCRIPTION OF EMBODIMENT

Preferred embodiments of the present invention will be explained with reference to accompanying drawings. It is not intended that this invention be limited to the embodiment described below.

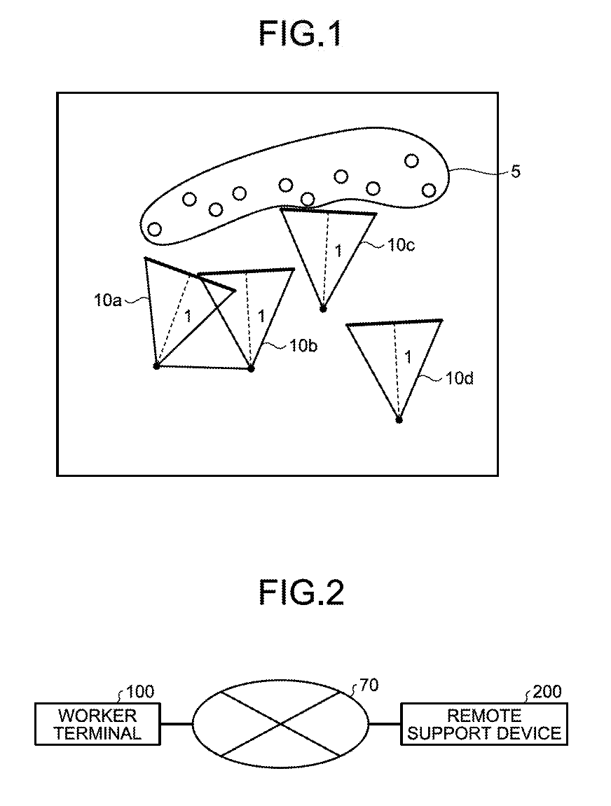

A referential technology that generates a three-dimensional panorama image will be explained before explanation of the present embodiment. The referential technology to be explained hereinafter is not a conventional technology. FIG. 1 is a diagram illustrating a referential technology. The referential technology estimates, by a monocular SLAM function, position/posture information of a camera and a characteristic point map that indicates the three-dimensional position of each of the characteristic points 5 in an image. The referential technology estimates, by the monocular SLAM function, the position of the camera that refers the world coordinate system. The referential technology arranges, for example, three-dimensional image drawing objects 10a to 10d on the basis of the position/posture of the camera at each time to generate a three-dimensional panorama image.

The scales of the three-dimensional image drawing objects 10a to 10d generated by the referential technology are decided on the basis of an internal parameter of the camera, and once decided scale is fixed. Therefore, as in the referential technology, when the three-dimensional image drawing objects 10a to 10d are arranged with the scales being fixed, every image is arranged in a certain size at the position that is away from the position of the camera along an eye direction by a unit length of the three-dimensional space. From this, mismatch of image occurs between the three-dimensional image drawing objects 10a to 10d, and the three-dimensional panorama image is not appropriately generated, and thus the exact grasping of a working field by a remote supporter may be difficult.

In the referential technology, when a worker continues capturing only by rotational motion while suppressing translational motion of the camera, or performs capturing so that the distance from the camera to a capturing target accords to a unit length of the three-dimensional space, the error of the three-dimensional panorama image can be reduced. However, in the aforementioned method, the burden to be given to the worker is large.

Next, a configuration of a system according to the present embodiment will be explained. FIG. 2 is a diagram illustrating a configuration of the system according to the present embodiment. As illustrated in FIG. 2, this system includes a worker terminal 100 and a remote support device 200. The worker terminal 100 and the remote support device 200 are mutually connected via a network 70.

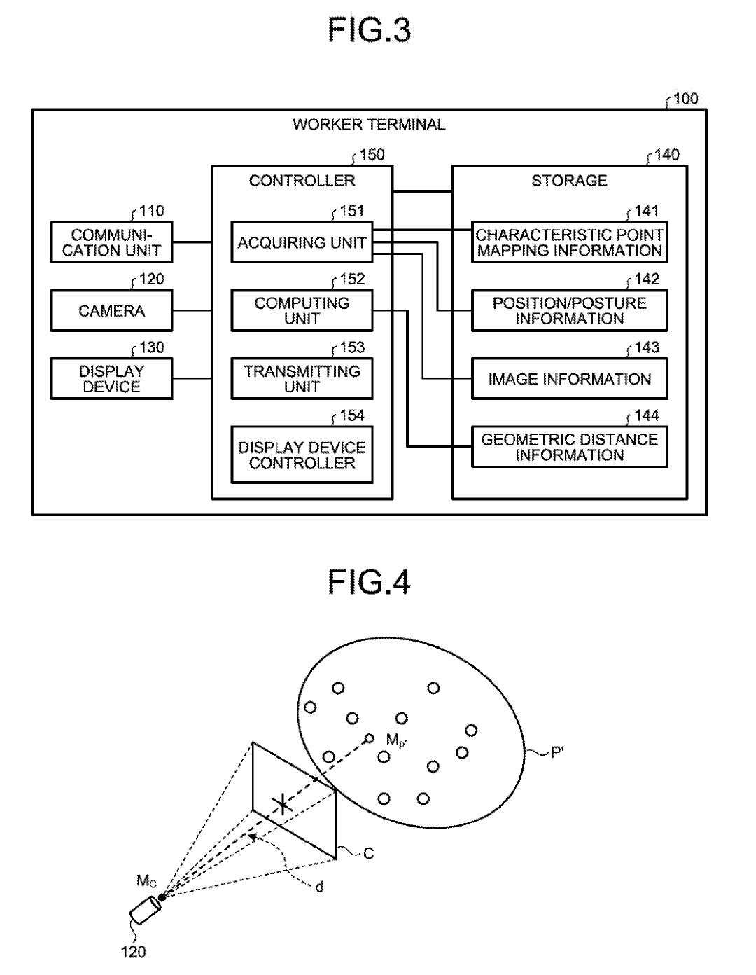

The worker terminal 100 is a terminal device that is worn by a worker that works in a working field. FIG. 3 is a functional block diagram illustrating a configuration of the worker terminal according to the present embodiment. As illustrated in FIG. 3, the worker terminal 100 includes a communication unit 110, a camera 120, a display device 130, a storage 140, and a controller 150.

The communication unit 110 is a processing unit that executes data communication with the remote support device 200 via the network 70. The communication unit 110 corresponds to, for example, a communication device. The controller 150 to be mentioned later exchanges information with the remote support device 200 via the communication unit 110.

The camera 120 is a camera to be worn by a worker. The camera 120 is connected to the worker terminal 100 by wireless communication or the like. The camera 120 is a compact camera such as a Head Mounted Camera (HMC) and a wearable Charge Coupled Device (CCD). The camera 120 captures an image of a captured region, and outputs information on the captured image to the worker terminal 100.

The display device 130 is a display device that displays information output from the controller 150. The display device 130 is a wearable display device such as a Head Mounted Display (HMD), from/to which the audio can be output/input. For example, the display device 130 displays instruction information and the like by an indicator, which is transmitted from the remote support device 200.

The storage 140 stores characteristic point mapping information 141, position/posture information 142, image information 143, and geometric distance information 144. The storage 140 corresponds to a semiconductor memory element such as a Random Access Memory (RAM), a Read Only Memory (ROM), or a flash memory, and a storage device such as a Hard Disk Drive (HDD).

The characteristic point mapping information 141 is information in which a plurality of characteristic points included in the image information that is captured by the camera 120 and three-dimensional coordinates of the characteristic points are associated, respectively.

The position/posture information 142 is information that indicates the position and the posture of the camera 120 at the timing when the camera 120 captures the image information 143.

The image information 143 is information on images captured by the camera 120. The geometric distance information 144 indicates the distance from the camera 120 to a subject.

The controller 150 includes an acquiring unit 151, a computing unit 152, a transmitting unit 153, and a display device controller 154. The controller 150 corresponds to an integrated device such as an Application Specific Integrated Circuit (ASIC) or a Field Programmable Gate Array (FPGA). The controller 150 corresponds to an electronic circuit of a Central Processing Unit (CPU), a Micro Processing Unit (MPU), etc.

The acquiring unit 151 is a processing unit that acquires information on characteristic points of a subject included in the image information that is captured by the camera 120 and position/posture information of the camera 120. The acquiring unit 151 registers the information on the characteristic point of the subject in the characteristic point mapping information 141. The acquiring unit 151 stores position/posture information of the camera 120 in the storage 140 as the position/posture information 142. The acquiring unit 151 stores image information that is captured by the camera 120 in the storage 140 as the image information 143.

One example of a process, by which the acquiring unit 151 calculates the information on a characteristic point, will be explained. The acquiring unit 151 acquires image information from the camera 120, and extracts a characteristic point from the image information. For example, the acquiring unit 151 executes an edge detecting process for the image information to extract a characteristic point from the image information.

The acquiring unit 151 compares characteristic points of the first image information captured by the camera 120 at time T1 with characteristic points of the second image information captured by the camera 120 at time T2 to associate the same characteristic point with each other. The acquiring unit 151 compares characteristic amount of the characteristic points to determine that a combination of characteristic points in which difference in the characteristic amount is minimum as the same characteristic point. The characteristic amount of a characteristic point corresponds to the brightness distribution, the edge intensity, etc. around the characteristic point.

The acquiring unit 151 calculates a three-dimensional coordinate of a characteristic point on the basis of a coordinate of the same characteristic point that is included in the first image information and the second image information, and the principle of stereo matching. The acquiring unit 151 repeatedly executes the aforementioned process about each characteristic point, and calculates a three-dimensional coordinate of each characteristic point to acquire information on the characteristic points.

One example of a process by which the acquiring unit 151 calculates position/posture information on the camera 120 will be explained. The acquiring unit 151 may estimate the position/posture information on the camera by the monocular SLAM function. For example, the acquiring unit 151 converts, on the basis of a conversion table, the three-dimensional coordinate of each characteristic point of the characteristic point mapping information 141 to a two-dimensional coordinate to project each characteristic point to the present image information captured by the camera 120. In the conversion table, a two-dimensional coordinate, which is acquired from a three-dimensional coordinate of a characteristic point, differs in accordance with the position/posture information of the camera 120.

The acquiring unit 151 searches the position/posture information of the camera 120, by which the error between a characteristic point on the image information and a projected characteristic point is minimum, with regard to the same characteristic point. The acquiring unit 151 acquires the position/posture information by which the error is minimum as the present position/posture information on the camera 120.

The computing unit 152 is a processing unit that computes a geometric distance from the camera 120 to the subject on the basis of the characteristic point mapping information 141 and the position/posture information 142. The computing unit 152 writes information on the geometric distance as the geometric distance information 144. The computing unit 152 stores the geometric distance information 144 in the storage 140.

One example of a process by which the computing unit 152 computes a geometric distance will be explained. A set of the characteristic points included in the characteristic point mapping information 141 may be referred to as “set P”. The computing unit 152 extracts, within the set “P”, a set “P′⊂P” of the characteristic points that can be observed by the camera 120.

The computing unit 152 may extract the characteristic points of the characteristic point mapping information 141, which respectively have association with the characteristic points of the image information captured by the camera 120, as a set “P′”. In the following explanation of the computing unit 152, the image information captured by the camera 120 may be referred to as “image information C”. The computing unit 152 may project the set “P” on the image information C, and further may extract a set of characteristic points that, for example, exist inside the image information C as the set “P”.

The computing unit 152 computes a geometric distance “d” on the basis of a formula (1). In the formula (1), “M_{c}” is a three-dimensional coordinate of the camera 120. The three-dimensional coordinate of the camera 120 is included in the position/posture information 142. “M_{P′}” is a representative three-dimensional coordinate that is calculated form the three-dimensional coordinate of each characteristic point of the set “P′”. “M_{C}” and “M_{P}” are to be expressed by the same coordinate system.

d=|M_{C}−M_{P′}| (1)

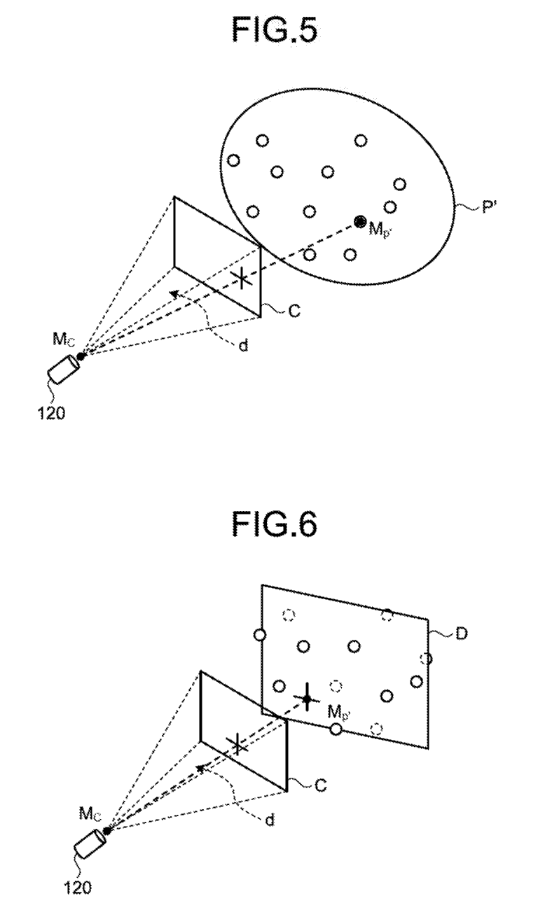

One example of “M_{P′}” in the set “P′” will be explained. FIGS. 4 to 6 are diagrams illustrating examples of “M_{P′}” in the set “P′”. For example, as illustrated in FIG. 4, the computing unit 152 may set an average value of three-dimensional coordinates of characteristic points included in the set “P′” as “M_{P′}”. As illustrated in FIG. 5, the computing unit 152 may set, within the characteristic points “p∈P” of the set “P′”, a three-dimensional coordinate of a point from which the distance to “M_{C}” is median as “M_{P′}”. As illustrated in FIG. 6, the computing unit 152 may compute a least square plane D that passes through the set “P′”, and may set a three-dimensional coordinate on the least square plane D, from which the distance to “M_{C}” is minimum as “M_{P′}”.

The computing unit 152 may compute the geometric distance “d” every time when it acquires the image information from the camera 120, or at previously set frequency.

The transmitting unit 153 is a processing unit that transmits an image frame that includes the characteristic point mapping information 141, the position/posture information 142, the image information 143, and the geometric distance information 144, which are stored in the storage 140, to the remote support device 200. For example, the transmitting unit 153 transmits the image frame to the remote support device 200 every time when the position/posture information 142 or the geometric distance information 144 is updated on the basis of the updated image information 143 after the image information 143 is updated. The transmitting unit 153 may store the information on an internal parameter of the camera 120 in the image frame.

The display device controller 154 is a processing unit that causes, in such a case that it receives instruction information from the remote support device 200, the display device 130 to display the received instruction information.

The remote support device 200 is a device that receives image frames from the worker terminal 100 to generate a three-dimensional panorama image. An indicator that uses the remote support device 200 refers to the three-dimensional panorama image and the like to grasp a situation of field.

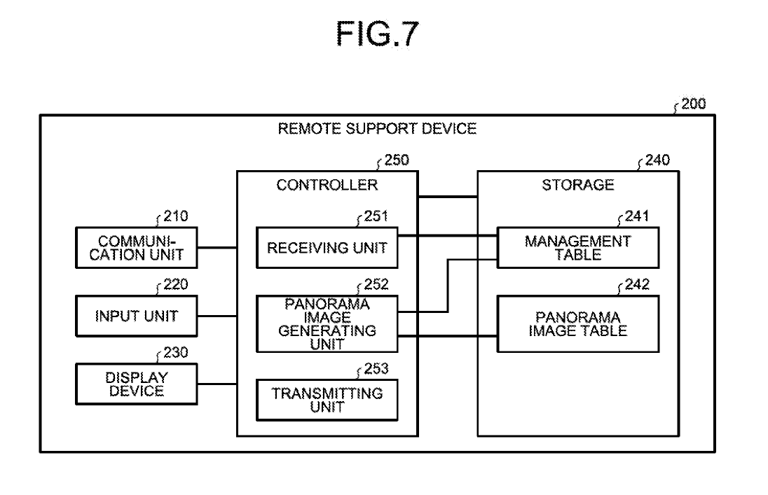

FIG. 7 is a functional block diagram illustrating a configuration of the remote support device according to the present embodiment. As illustrated in FIG. 7, the remote support device 200 includes a communication unit 210, an input unit 220, a display device 230, a storage 240, and a controller 250.

The communication unit 210 is a processing unit that executes data communication with the worker terminal 100 via the network 70. The communication unit 210 corresponds to, for example, a communication device. The controller 250 to be mentioned later exchanges information with the worker terminal 100 via the communication unit 210.

The input unit 220 is an input device that is for inputting various kinds of information to the remote support device 200. The input unit 220 corresponds to, for example, a keyboard, a mouse, a touch panel, etc. The indicator operates the input unit 220 to input various kinds of instruction information.

The display device 230 is a display device that displays information output from the controller 250. For example, the display device 230 displays information on a three-dimensional panorama image, which is output from the controller 250. The display device 230 corresponds to, for example, a liquid crystal display, a touch panel, etc.

The storage 240 includes a management table 241 and a panorama image table 242. The storage 240 corresponds to a semiconductor memory element such as a RAM, a ROM, or a flash memory, and a storage device such as a HDD.

The management table 241 is a table that stores an image frame transmitted from the worker terminal 100. As described above, the image frame includes the characteristic point mapping information 141, the position/posture information 142, the image information 143, and the geometric distance information 144.

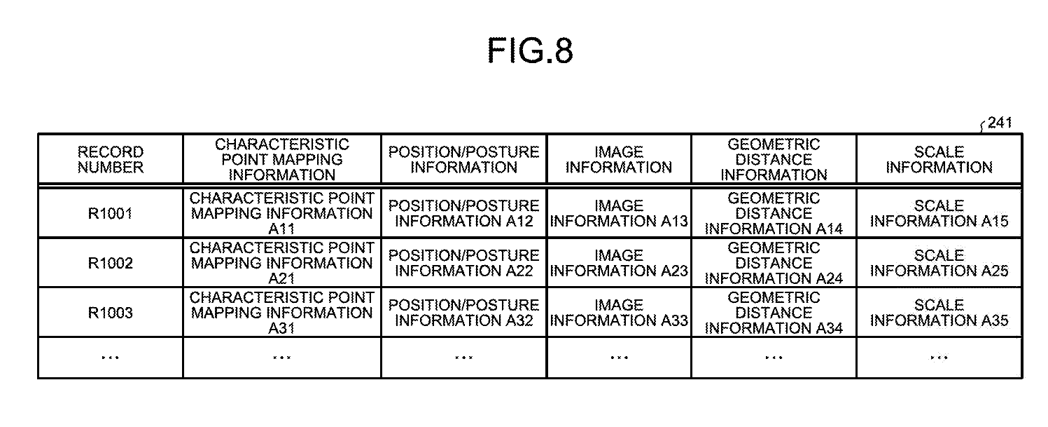

FIG. 8 is a diagram illustrating one example of a data structure of the management table. As illustrated in FIG. 8, the management table 241 stores the record number, the characteristic point mapping information, the position/posture information, the image information, the geometric distance information, and the scale information with them associated with each other. The record number is information by which each record of the management table 241 are uniquely identified. The explanation about the characteristic point mapping information, the position/posture information, the image information, and the geometric distance information is similar to aforementioned. The characteristic point mapping information, the position/posture information, the image information, and the geometric distance information that are included in the same image frame are stored in the management table 241 with them respectively associated with the same record number. The scale information is information that indicates the scale of a three-dimensional image drawing object, and is calculated by a panorama image generating unit 252 to be mentioned later.

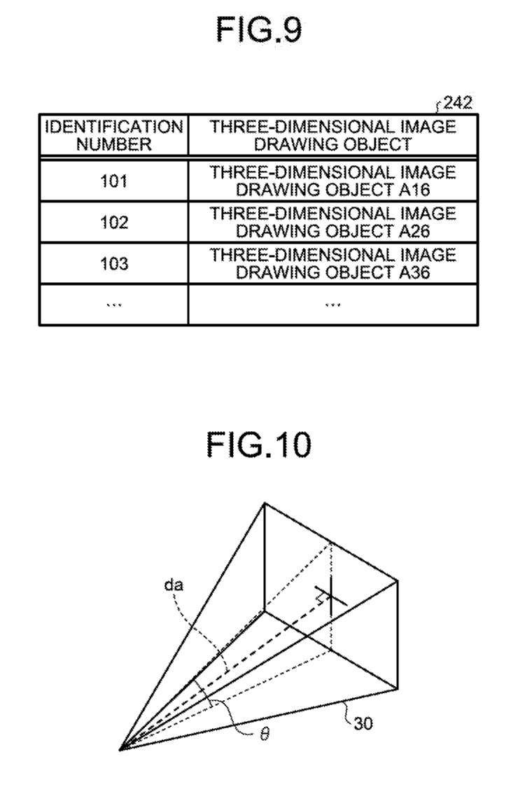

The panorama image table 242 is a table that holds information on a plurality of the three-dimensional image drawing objects that constitutes a three-dimensional panorama image. FIG. 9 is a diagram illustrating one example of a data structure of a panorama image table. As illustrated in FIG. 9, the panorama image table 242 associates the identification number with the three-dimensional image drawing object. The identification number is information by which the three-dimensional image drawing object is uniquely identified. The three-dimensional image drawing object is information that is arranged in such a case that the three-dimensional panorama image is generated.

For example, a three-dimensional image drawing object A16 is generated on the basis of the record of the record number “R1001” in the management table 241. A three-dimensional image drawing object A26 is generated on the basis of the record of the record number “R1002” in the management table 241. A three-dimensional image drawing object A36 is generated on the basis of the record of the record number “R1003” in the management table 241. Not illustrated here, however, other three-dimensional image drawing objects are similarly associated with the records in the management table 241.

The controller 250 includes a receiving unit 251, the panorama image generating unit 252, and a transmitting unit 253. The controller 250 corresponds to an integrated device such as an ASIC or a FPGA. The controller 250 corresponds to an electronic circuit of a CPU, a MPU, etc. The panorama image generating unit 252 is one example of the controller 250.

The receiving unit 251 is a processing unit that receives an image frame from the worker terminal 100. The receiving unit 251 associates the characteristic point mapping information, the position/posture information, the image information, and the geometric distance information, which are included in the received image frame, with the record number every time when it receives an image frame, and stores them in the management table 241.

The panorama image generating unit 252 calculates the scale information on the basis of the geometric distance information at each record number stored in the management table 241. The panorama image generating unit 252 generates a plurality of three-dimensional image drawing objects on the basis of each piece of generated scale information, and arranges the plurality of three-dimensional image drawing objects on the basis of the position/posture information to generate a three-dimensional panorama image. The panorama image generating unit 252 outputs the information on the three-dimensional panorama image to the display device 230 to display it.

One example of a process by which the panorama image generating unit 252 calculates the scale information on the basis of the geometric distance information will be explained. The panorama image generating unit 252 generates a frustum-shaped reference object on the basis of an internal parameter of the camera 120. The internal parameter of the camera 120 is expressed by a formula (2). The panorama image generating unit 252 is assumed to preliminarily acquire information on an internal parameter “K” from the worker terminal 100.

$$K = [ \begin{matrix}{f}_{x} & s & {c}_{x} \\ 0 & α {f}_{y} & {c}_{y} \\ 0 & 0 & 1\end{matrix} ] \qquad ( 2 )$$

In the formula (2), “fₓ” and “f_{y}” express a focal distance of the camera 120. For example, “fₓ” expresses the focal distance in the x-direction based on the position of the camera 120, and “f_{y}” expresses the focal distance in the y-direction based on the position of the camera 120. Moreover, “s” expresses a skew of the camera 120, “α” expresses an aspect ratio of the camera 120, and “cₓ” and “c_{y}” are coordinates that express the center of an image that is captured by the camera 120.

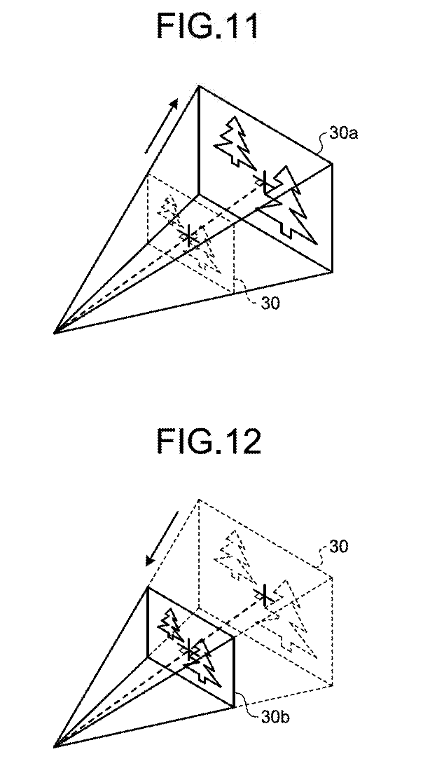

The panorama image generating unit 252 calculates an aspect ratio “r” of a reference object on the basis of a formula (3). The panorama image generating unit 252 derives an angle of view θ of a reference object on the basis of a formula (4). FIG. 10 is a diagram illustrating one example of a reference object. As illustrated in FIG. 10, the angle of view of a reference object 30 is “θ”, and the aspect ratio defined by the formula (3) is “r”. The height of the reference object 30 is a unit length “da”.

$$\begin{matrix}r = \frac{{f}_{y}}{{f}_{x}} & ( 3 ) \\ θ = 2 {tan}^{- 1} ( \frac{{c}_{y}}{{f}_{y}} ) & ( 4 )\end{matrix}$$

The panorama image generating unit 252 generates the reference object 30, and then calculates scale information of each piece of geometric distance information. The panorama image generating unit 252 converts the unit length “da” to a geometric distance while maintaining the aspect ratio “r” and the angle of view “θ” of the reference object 30 constant to deform the scale of the reference object 30. The reference object 30 whose scale is changed is defined as the scale information.

FIGS. 11 and 12 are diagrams illustrating examples of a changing process of the scale of the reference object. As illustrated in FIG. 11, in such a case that the geometric distance “d” is larger than “1” (d>1), the panorama image generating unit 252 executes scale deformation of the reference object 30 as an object 30a. The object 30a corresponds to the enlarged reference object 30 by the enlargement factor “d”.

As illustrated in FIG. 12, in such a case that the geometric distance “d” is larger than “0” and smaller than “1” (0<d<1), the panorama image generating unit 252 executes scale conversion of the reference object 30 as an object 30b. The object 30b corresponds to the reduced reference object 30 by the reduction factor “d”.

As described above, the panorama image generating unit 252 enlarges or reduces the reference object on the basis of the geometric distance information to generate the object. The panorama image generating unit 252 stores information on the object, which includes the angle of view “θ”, the aspect ratio “r”, and the geometric distance information on the object, in the management table 241 as the scale information. The panorama image generating unit 252 executes texture mapping of the image information on the bottom face of the object to generate a three-dimensional image drawing object, and stores it in the panorama image table 242.

The panorama image generating unit 252 repeatedly executes the aforementioned process with regard to information on each record number in the management table 241, and thus generates a three-dimensional image drawing object whose scale is different for each piece of geometric distance information. The panorama image generating unit 252 stores each three-dimensional image drawing object in the panorama image table 242.

By the way, in the aforementioned example, the panorama image generating unit 252 converts the scale of the reference object by directly using the geometric distance notified from the worker terminal 100, however, is not limit thereto. For example, the panorama image generating unit 252 may calculate the optimum value of each geometric distance as illustrated hereinafter, and may generate a three-dimensional image drawing object by using the optimum value of the geometric distance.

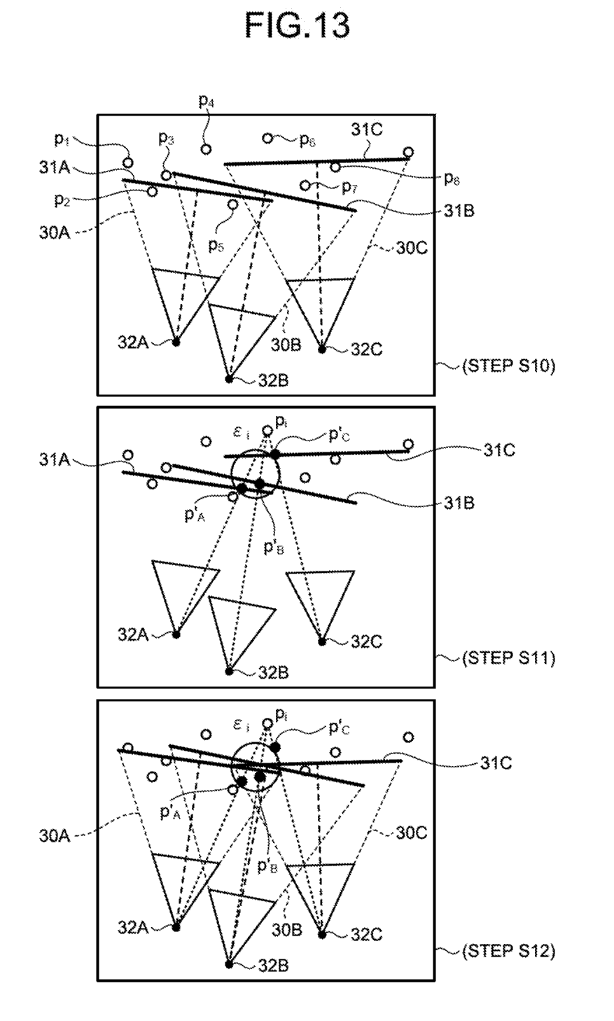

FIG. 13 is a diagram illustrating a calculating process of an optimum value of a geometric distance. Step S10 in FIG. 13 will be explained. As illustrated in FIG. 13, characteristic points “p₁ to p₈” are assumed to exist. Three-dimensional image drawing objects 30A to 30C are assumed to be arranged on the basis of the position/posture information on the camera 120. For the three-dimensional image drawing object 30A, an image 31A is texture mapped. For the three-dimensional image drawing object 30B, an image 31B is texture mapped. For the three-dimensional image drawing object 30C, an image 31C is texture mapped. A position 32A is the position of the camera 120 in which the image 31A is captured. A position 32B is the position of the camera 120 in which the image 31B is captured. A position 32C is the position of the camera 120 in which the image 31C is captured.

Step S11 will be explained. For convenience of explanation, a characteristic point “P₆” is focused, and referred to as “pᵢ”. A position “p′_{A}” is the position in which a straight line that passes through the characteristic point “pᵢ” and the position 32 A intersects with the image 31A. A position “p′_{B}” is the position in which a straight line that passes through the characteristic point “pᵢ” and the position 32 B intersects with the image 31B. A position “p′_{c}” is the position in which a straight line that passes through the characteristic point “pᵢ” and the position 32 C intersects with the image 31C. For example, the error between “p′_{A}”, “p′_{B}”, and “p′_{C}” is expressed “εᵢ”. The panorama image generating unit 252 similarly specifies the error “ε” with regard to other characteristic points “p₁” to “p₅”, and “p₇” to “p₈”.

Step S12 will be explained. The panorama image generating unit 252 searches a value of a geometric distance so that a total value E(s) of each of the errors “ε” is minimum to specify new scale information on the three-dimensional image drawing objects 30 A to 30 C.

With regard to a geometric distance set “D={dᵢ}” of a camera set “Γ={Cᵢ} (i=1, 2, etc.)”, a usage by which the optimum geometric distance set, which, for example, minimizes the error between the three-dimensional panorama images, is derived will be explained hereinafter. For example, “Cᵢ” corresponds to respective positions of the camera 120. The geometric distance set is defined by a formula (5).

D={dᵢ} (5)

The panorama image generating unit 252 extracts, with regard to each characteristic point “pⱼ∈P (j=1, 2, etc.)” in a three-dimensional characteristic point map, a camera set “Γⱼ⊂Γcf” by which the characteristic point “pⱼ” can be observed. The panorama image generating unit 252 may extract a set of cameras that have two-dimensional characteristic points respectively corresponding to the characteristic points “pⱼ”, or may extract a set of cameras in which respectively projected points of the characteristic points “pⱼ” exist in an image.

With regard to each three-dimensional point “pⱼ∈P” of the three-dimensional characteristic point map, an error “εⱼ(Dⱼ)” relating to the geometric distance set “Dⱼ⊂D”, which corresponds to the camera set “Γⱼ”, is defined.

The definition of the error “εⱼ(Dⱼ)” based on a dispersion of the three-dimensional projected point will be explained as an example. First, the three-dimensional image drawing object of “Cᵢ” that is deformed by the geometric distance “dᵢ∈Dⱼ” corresponding to the camera “Cᵢ∈Γⱼ” will be exemplified. The three-dimensional image drawing object corresponds to the three-dimensional image drawing objects 30A to 30C, etc. illustrated in FIG. 13. A three-dimensional projected point “p′_{i,j}” of “pⱼ” for a three-dimensional image surface of the three-dimensional image drawing object is calculated on the basis of formulas (6), (7), and (8).

$$\begin{matrix}W [ \begin{matrix}{x}_{i , j} \\ 1\end{matrix} ] = {R}_{i} {p}_{j} + {t}_{i} & ( 6 ) \\ {X}_{i , j} = {d}_{i} [ \begin{matrix}{x}_{i , j} \\ 1\end{matrix} ] & ( 7 ) \\ {p}_{i , j}^{′} = {R}_{i}^{T} {X}_{i , j} - {R}_{i}^{T} {t}_{i} & ( 8 )\end{matrix}$$

Respective “Rᵢ” and “tᵢ” included in the formulas (6) and (8) are a rotation matrix “Rᵢ” and a translation vector “tᵢ” that are for converting the world coordinate system to the coordinate system of the camera “Cᵢ”. Herein, “x_{i,j}” is a two-dimensional projected point of “pⱼ” for a camera in which the camera “Cᵢ” is normalized. The camera in which the camera “Cᵢ” is normalized is a camera in which the rotation matrix Rᵢ, the translation vector tᵢ, and an internal parameter are third order unit matrices, respectively. “X_{i,j}” in the formulas (7) and (8) is a three-dimensional coordinate of “p′_{i,j}” in the coordinate system of the camera “Cⱼ”. “Rᵢ^{T}” is a transpose of “Rᵢ”, and “W” is an arbitrary real number.

Next, the panorama image generating unit 252 calculates the dispersion “εⱼ(Dⱼ)” of the three-dimensional projected point “p′_{i,j}” in the camera set “Γⱼ” by formulas (9) and (10). The formula (9) is for deriving the average of the three-dimensional projected points “p′_{i,j}” in the camera set “Γⱼ”.

$$\begin{matrix}{\overline{p}}_{j}^{′} = \frac{1}{\vert {Γ}_{j} \vert} {\sum }_{i}^{\vert {Γ}_{j} \vert} {p}_{i , j}^{′} & ( 9 ) \\ ɛ ( {D}_{j} ) = \frac{1}{\vert {Γ}_{j} \vert} {\sum }_{i}^{\vert {Γ}_{j} \vert} {( {p}_{i , j}^{′} - {\overline{p}}_{j}^{′} )}^{2} & ( 10 )\end{matrix}$$

Next, the sum of the error “εⱼ(Dⱼ)” derived in all of the “pⱼ∈P” is defined, as in a formula (11), as an energy function “E(D)” relating to the geometric distance set “D”. The panorama image generating unit 252 derives a geometric distance set in which the energy function “E(D)”, which is defined by a formula (12), is minimized.

$$\begin{matrix}E ( D ) = {\sum }_{i}^{\vert P \vert} {ɛ}_{j} ( {D}_{j} ) & ( 11 ) \\ \hat{D} = arg {min}_{D} E ( D ) & ( 12 )\end{matrix}$$

The panorama image generating unit 252 derives a geometric distance set, and then updates each geometric distance information in the management table 241. Moreover, the panorama image generating unit 252 updates the scale information on the management table 241 and the three-dimensional image drawing object of the panorama image table 242 on the basis of the updated geometric distance information.

The panorama image generating unit 252 arranges each of the three-dimensional image drawing objects in the panorama image table 242 on the basis of the position/posture information to generate a three-dimensional panorama image. For example, the panorama image generating unit 252 arranges the three-dimensional image drawing object A16 on the basis of the position/posture information A12. The panorama image generating unit 252 arranges the three-dimensional image drawing object A26 on the basis of the position/posture information A22. The panorama image generating unit 252 arranges the three-dimensional image drawing object A36 on the basis of the position/posture information A32. Similarly, the panorama image generating unit 252 arranges another three-dimensional image drawing object on the basis of the corresponding position/posture information. The panorama image generating unit 252 outputs information on the generated three-dimensional panorama image, and causes the display device 230 to display it.

The transmitting unit 253 is a processing unit that transmits the instruction information that is input by an indicator via the input unit 220, etc. to the worker terminal 100.

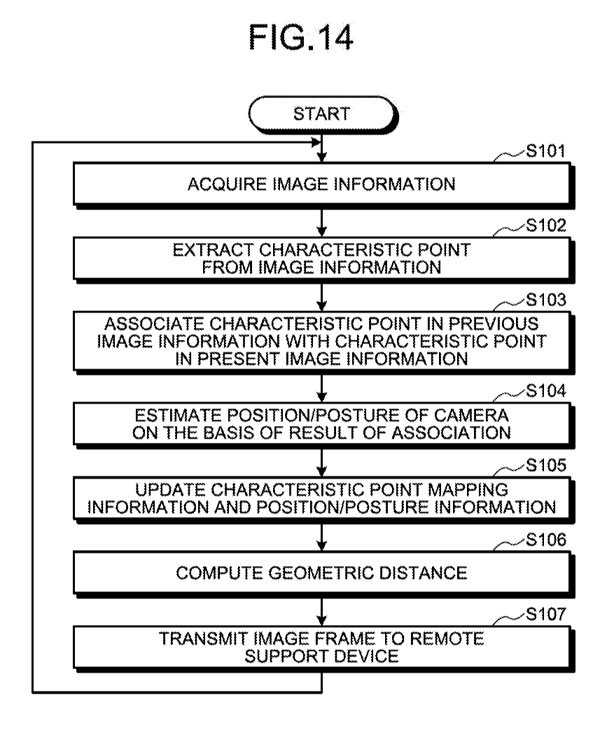

Next, one example of a processing procedure for the system according to the present embodiment will be explained. FIG. 14 is a flowchart illustrating a processing procedure by the worker terminal according to the present embodiment. As illustrated in FIG. 14, the acquiring unit 151 of the worker terminal 100 acquires image information from the camera 120 (Step S101). The acquiring unit 151 extracts a characteristic point from the image information (Step S102).

The acquiring unit 151 associates a characteristic point in the previous image information with a characteristic point in the present image information (Step S103). The acquiring unit 151 estimates the position/posture of the camera 120 on the basis of the result of the association (Step S104). The acquiring unit 151 updates the characteristic point mapping information 141 and the position/posture information (Step S105).

The computing unit 152 of the worker terminal 100 computes a geometric distance on the basis of the characteristic point mapping information 141 and the position/posture information 142 (Step S106). The transmitting unit 153 of the worker terminal 100 transmits an image frame to the remote support device 200 (Step S107), and shifts to Step S101. For example, the image frame includes the characteristic point mapping information 141, the position/posture information 142, the image information 143, the geometric distance information 144, an internal parameter of the camera 120, etc.

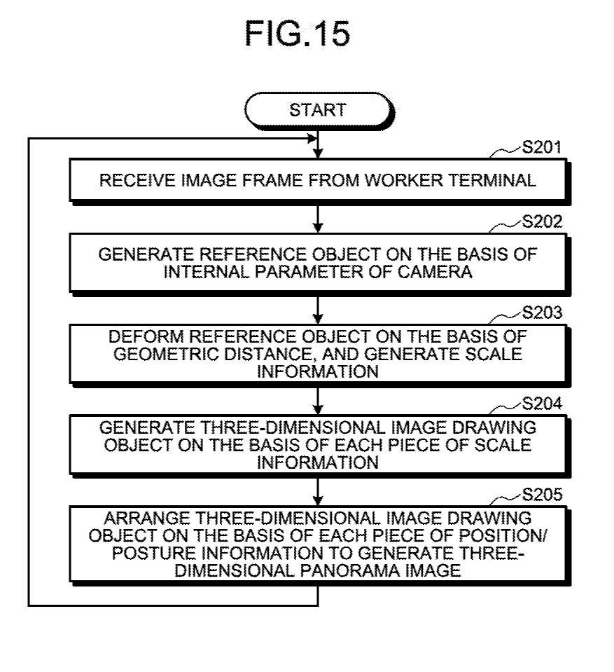

FIG. 15 is a flowchart illustrating a processing procedure by the remote support device according to the present embodiment. As illustrated in FIG. 15, the receiving unit 251 of the remote support device 200 receives an image frame from the worker terminal 100 (Step S201).

The panorama image generating unit 252 of the remote support device 200 generates a reference object on the basis of an internal parameter of the camera 120 (Step S202). The panorama image generating unit 252 deforms the reference object on the basis of the geometric distance, and generates scale information (Step S203).

The panorama image generating unit 252 generates a three-dimensional image drawing object on the basis of each piece of the scale information (Step S204). The panorama image generating unit 252 arranges the three-dimensional image drawing object on the basis of each piece of the position/posture information to generate a three-dimensional panorama image (Step S205), and shifts to Step S201.

Next, effects of the system according to the present embodiment will be explained. The worker terminal 100 acquires information on characteristic points that is included in image information captured by the camera 120 and position/posture information on the camera 120, computes a geometric distance from the camera 120 to a subject by using the acquired information, and notifies the remote support device 200 of it. The remote support device 200 changes the scale of the image information that is arranged in order to generate a three-dimensional panorama image in accordance with the geometric distance. For example, the remote support device 200 adjusts the scale of the image information in accordance with the geometric distance, and arranges the image information whose scale is adjusted to generate a panorama image. Therefore, by employing the present embodiment, the three-dimensional panorama image can be appropriately generated compared with the conventional technology, the referential technology, etc.

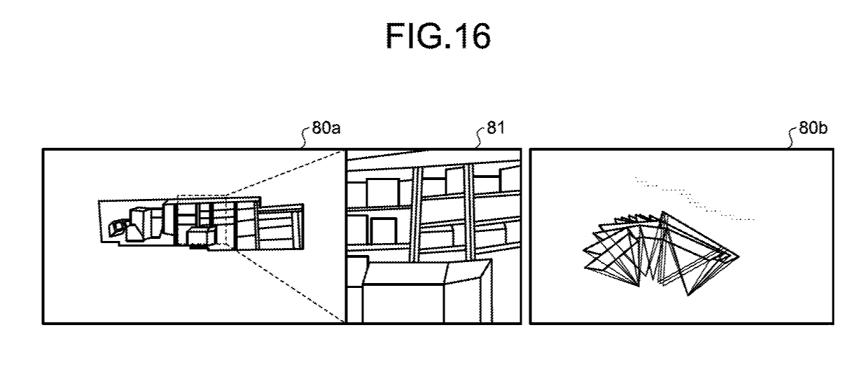

One example of the three-dimensional panorama image generated by the present embodiment and that generated by the referential technology will be explained. FIG. 16 is a diagram illustrating a conventional referential three-dimensional panorama image. A three-dimensional panorama image 80a and a bird's eye view 80b thereof are illustrated in FIG. 16. As illustrated in the bird's eye view 80b, the scale of the three-dimensional image drawing object is fixed in the referential technology. Therefore, for example, the mismatch of images occurs as illustrated in a partial image 81 of the three-dimensional panorama image 80a, and thus the three-dimensional panorama image is not appropriately generated.

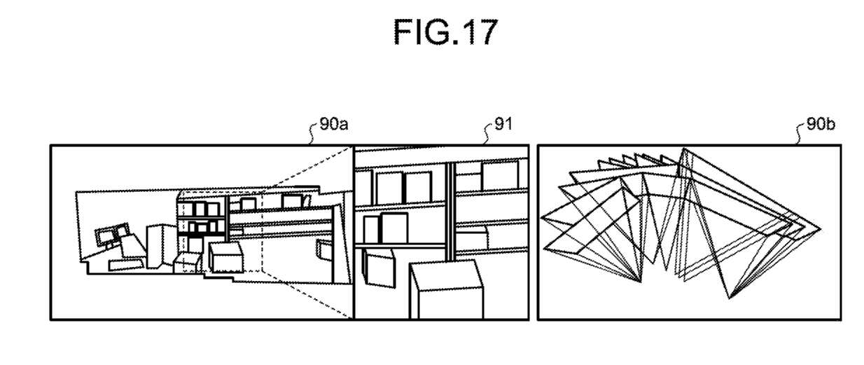

FIG. 17 is a diagram illustrating a three-dimensional panorama image that is generated in the present embodiment. A three-dimensional panorama image 90a and a bird's eye view 90b thereof are illustrated in FIG. 17. As described above, in the present embodiment, the scale of the image information, which is arranged in order to generate a three-dimensional panorama image in accordance with the geometric distance, is changed. Therefore, for example, as illustrated in a partial image 91 of the three-dimensional panorama image 90a, occurrence of the mismatch of images can be restrained, and a three-dimensional panorama image can be appropriately generated.

The system according to the present embodiment changes a unit length of a reference object in accordance with the distance from the camera 120 to a subject while maintaining the aspect ratio and the angle of view of the reference object constant, and adjusts the scale of the image information in accordance with the aspect ratio of the object that indicates the changed reference object. Therefore, the three-dimensional panorama image can be efficiently generated.

The system according to the present embodiment arranges respective three-dimensional image drawing objects, and adjusts the scale of each of the three-dimensional image drawing objects so that the position of the same characteristic point included in each piece of the image information is minimum. Therefore, occurrence of the misalignment between the three-dimensional panorama images can be more reduced.

By the way, in the aforementioned embodiment, the process is shared by the worker terminal 100 and the remote support device 200 in such a case that the three-dimensional panorama image is generated, however is not limited thereto. For example, a processing unit that generates a three-dimensional panorama image may be merged with the worker terminal 100 or the remote support device 200.

For example, the panorama image generating unit 252 may be further arranged in the worker terminal 100, and the worker terminal 100 may generate a three-dimensional panorama image. Or, the acquiring unit 151 and the computing unit 152 may be further arranged in the remote support device 200, and the remote support device 200 may generate a three-dimensional panorama image. The worker terminal 100 that further includes the panorama image generating unit 252 or the remote support device 200 that further includes the acquiring unit 151 and the computing unit 152 is one example of an information processing device.

The case, in which the acquiring unit 151 of the worker terminal 100 according to the present embodiment calculates a three-dimensional coordinate of a characteristic point on the basis of the principle of stereo matching by using images information captured at different times, is explained, however, not limited thereto. For example, the acquiring unit 151 may specify a three-dimensional coordinate of the characteristic point by using a distance sensor. The acquiring unit 151 may calculate a three-dimensional position of a characteristic point on the basis of a time during which the light that is irradiated from the distance sensor to a characteristic point is reflected from the characteristic point and reaches again the distance sensor, and the velocity of light.

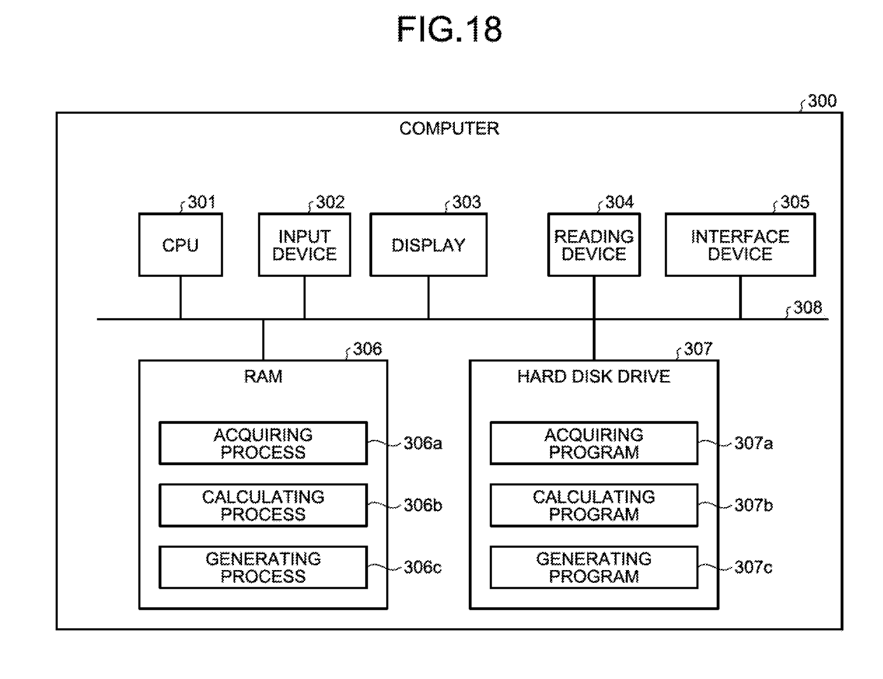

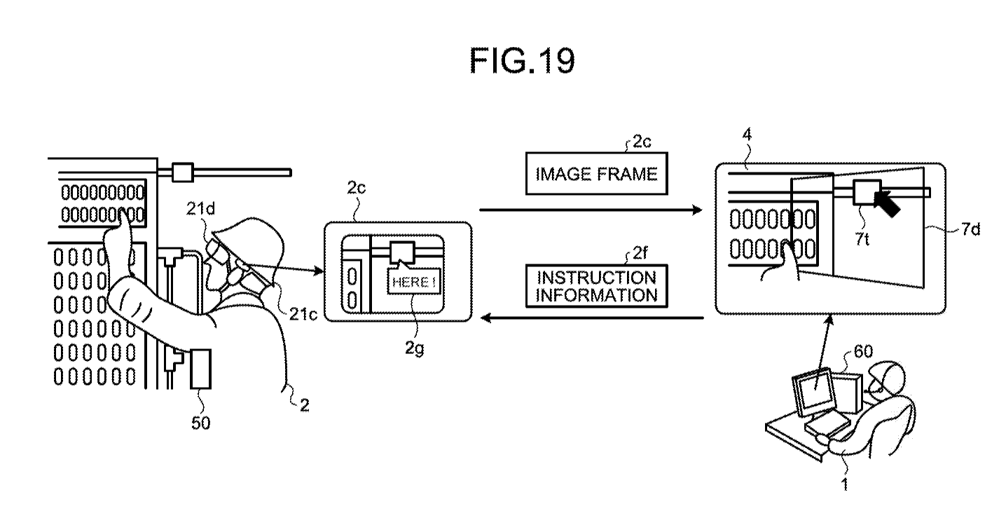

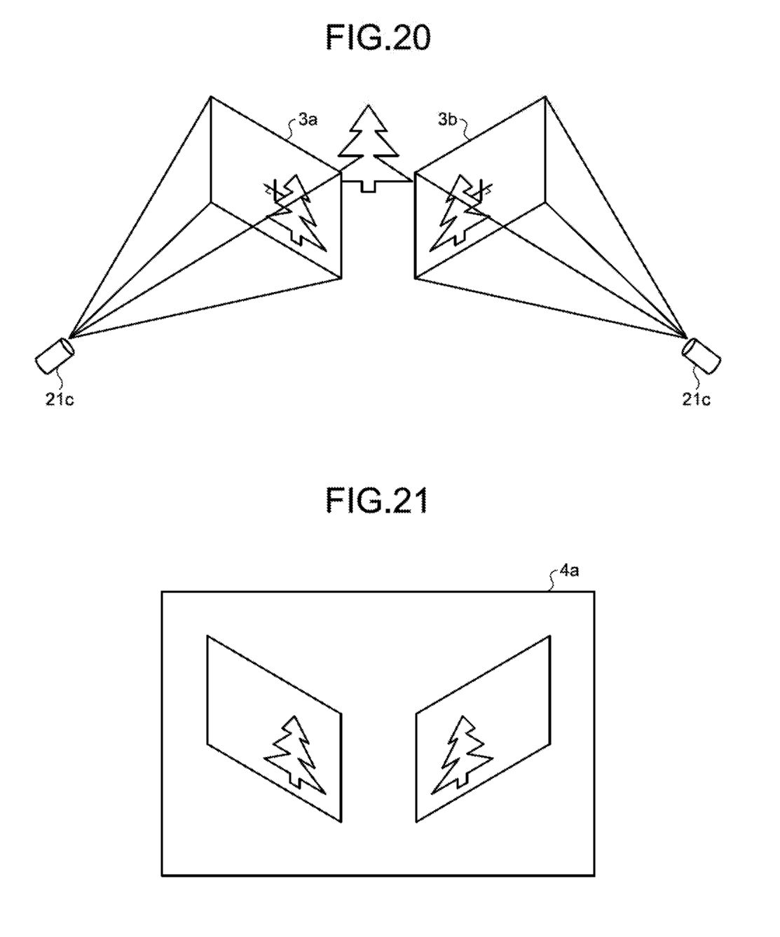

Next, one example of a computer will be explained, which executes an information processing program that realizes the same functions as those of the worker terminal 100 and the remote support device 200 described in the aforementioned embodiment. FIG. 18 is a diagram illustrating one example of a computer that executes the information processing program.

As illustrated in FIG. 18, a computer 300 includes a CPU 301 that executes various operation processes, an input device 302 that receives input of data from a user, and a display 303. The computer 300 includes a reading device 304 that reads a program, etc. from a storage medium and an interface device 305 that exchanges data with another computer via a network. The interface device 305 may be connected to a camera. Moreover, the computer 300 includes a RAM 306 that temporarily stores various kinds of information, and a hard disk drive 307. The devices 301 to 307 are connected to a bus 308.

The hard disk drive 307 includes an acquiring program 307a, a calculating program 307b, and a generating program 307c. The CPU 301 reads the acquiring program 307a, the calculating program 307b, and the generating program 307c to expand them into the RAM 306.

The acquiring program 307a functions as the acquiring process 306a. The calculating program 307b functions as a calculating process 306b. The generating program 307c functions as a generating process 306c.

The process for the acquiring process 306a corresponds to the process by the acquiring unit 151. The process for the calculating process 306b corresponds to the process by the acquiring unit 152. The process for the generating process 306c corresponds to the process by the acquiring unit 252.

The acquiring program 307a, the calculating program 307b, and the generating program 307c need not be previously stored in the hard disk drive 307. For example, each program may be stored in “portable physical medium” such as a flexible disk (FD), a Compact Disc-ROM (CD-ROM), a Digital Versatile Disc (DVD), a magnet-optical disk, or an Integrated Circuit card (IC card), which is inserted into the computer 300, and the computer 300 may read and execute each of the programs 307a to 307c.

According to an aspect of the embodiment, a panorama image can be appropriately generated.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An information processing device comprising:
a processor that executes a process comprising:
acquiring information on a characteristic point of a subject, which is included in image information captured by a photographing device, and position/posture information of the photographing device;
computing a distance from the photographing device to the subject based on the information on the characteristic point and the position/posture information; and
changing a scale of image information that is arranged to generate a panorama image in accordance with the distance.

2. The information processing device according to claim 1, wherein the changing adjusts the scale of the image information in accordance with the distance, and arranges the image information whose scale is adjusted to generate the panorama image.

3. The information processing device according to claim 2, wherein the changing changes a first distance from a bottom face to an edge point of a reference object in accordance with a second distance from the photographing device to the subject while constantly maintaining an aspect ratio and an angle of view of the reference object, and adjusts the scale of the image information based on an object that indicates the changed reference object.

4. The information processing device according to claim 3, the process further comprising pasting the image information whose scale is adjusted on the bottom face of the object for each of pieces of the image information and arranging objects on which the pieces of the image information are pasted wherein the changing adjusts scales of the objects so that a position of a same characteristic point that is included in each of the pieces of image information is minimum.

5. An information processing method comprising:
acquiring information on a characteristic point of a subject, which is included in image information captured by a photographing device, and position/posture information of the photographing device, using a processor;
computing a distance from the photographing device to the subject based on the information on the characteristic point and the position/posture information, which are acquired in the acquiring, using the processor; and
changing a scale of image information that is arranged to generate a panorama image in accordance with the distance computed in the computing, using the processor.

6. The information processing method according to claim 5, wherein the changing adjusts the scale of the image information in accordance with the distance computed in the computing, and arranges the image information whose scale is adjusted to generate the panorama image.

7. The information processing method according to claim 6, wherein the changing changes a first distance from a bottom face to an edge point of a reference object in accordance with a second distance from the photographing device to the subject while constantly maintaining an aspect ratio and an angle of view of the reference object, and adjusting the scale of the image information based on an object that indicates the changed reference object.

8. The information processing method according to claim 7, the information processing method further comprising pasting the image information whose scale is adjusted on the bottom face of the object for each of pieces of the image information and arranging objects on which the pieces of the image information are pasted, wherein the changing adjusts scales of the objects so that a position of a same characteristic point that is included in each of the pieces of image information is minimum.

9. A non-transitory computer-readable recording medium having stored therein an information processing program that causes a computer to execute a process, the process including:
acquiring information on a characteristic point of a subject, which is included in image information captured by a photographing device, and position/posture information of the photographing device;
computing a distance from the photographing device to the subject based on the information on the characteristic point and the position/posture information, which are acquired in the acquiring; and
changing a scale of image information that is arranged to generate a panorama image in accordance with the distance computed in the computing.

10. The non-transitory computer-readable recording medium according to claim 9, wherein the changing adjusts the scale of the image information in accordance with the distance computed in the computing, and arranges the image information whose scale is adjusted to generate the panorama image.

11. The non-transitory computer-readable recording medium according to claim 10, wherein the changing changes a first distance from a bottom face to an edge point of a reference object in accordance with a second distance from the photographing device to the subject while constantly maintaining an aspect ratio and an angle of view of the reference object, and adjusts the scale of the image information based on an object that indicates the changed reference object.

12. The non-transitory computer-readable recording medium according to claim 11, the process further comprising pasting the image information whose scale is adjusted on the bottom face of the object for each of pieces of the image information and arranging objects on which the pieces of the image information are pasted wherein the changing adjusts scales of the objects so that a position of a same characteristic point that is included in each of the pieces of image information is minimum.
